(19) United States
(12) Patent Application Publication
(10) Pub. No.: US 2012/0311832 A1
(43) Pub. Date: Dec. 13, 2012

(54) Chemical Preservation of Corpses

(76) Inventors: Ryan Curtis, Sugar Land, TX (US); Sanjay Patel, Sugar land, TX (US)

(21) Appl. No.: 13/213,223

(22) Filed: Aug. 19, 2011

Related U.S. Application Data
(60) Provisional application No. 61/375,743, filed on Aug. 20, 2010.

(51) Int. Cl. A01N 1/00

(52) U.S. Cl. 27/22.1; 27/24.1

(57) ABSTRACT

Embodiments of the invention generally relate to methods, systems, and apparatus for the chemical preservation of dead bodies. While pumping embalming fluid in to the corpse, waste fluids such as blood may simultaneously be pumped out of the corpse to facilitate better distribution of embalming fluid and drainage of the waste fluids.

### REFERENCES TO OTHER APPLICATIONS

This application claims priority benefits under 35 U.S.C. §119 to provisional patent application number U.S. 61/375,743, filed on Aug. 20, 2010. This related patent application is herein incorporated by reference in its entirety.

### FIELD OF THE INVENTION

Embodiments of the invention generally relate to methods, systems, and apparatus for the chemical preservation of dead bodies.

### BACKGROUND

Upon death, a human body immediately begins decomposing, sometimes at a very rapid pace depending on the environment to which the body is exposed. By the time of a burial or cremation, which may be several days after death, decomposition may be well under way which may materially alter the appearance of the body.

For example, the intestines of a human body contain millions of micro-organisms which do not die with the body. Upon death, the micro-organisms may begin breaking down the dead cells of the intestines, and eventually attack other parts of the body. Furthermore, some dead cells may release chemicals (e.g., the pancreas may release digestive enzymes), which may also result in the break down and decomposition of the body.

The decomposition process may result in the release of undesirable substances and gas, which in turn may make the skin appear blue/green and blistered. Furthermore, the body may begin to swell at certain locations, the tongue may protrude, and fluids may ooze out of the mouth and/or nostrils. To add to the unpleasant sight, the body may also release extremely unpleasant gasses such as hydrogen sulphide, methane, etc. Bodies in such a condition can be very disturbing to perceive, especially to relatives who desire a final view of their loved one at a funeral.

Therefore, it is common to preserve a dead body via an embalming process which slows down decomposition.

### SUMMARY OF THE INVENTION

Embodiments of the invention generally relate to methods, systems, and apparatus for the chemical preservation of dead human bodies.

One embodiment of the invention provides an embalming method, generally comprising coupling an arterial tube to an artery of a corpse and an outlet of a pump, coupling a venous tube to a vein of the corpse and an inlet of the pump, pumping an embalming fluid into the corpse via the arterial tube, and pumping waste fluid out of the corpse via the venous tube while the embalming fluid is being pumped into the corpse via the arterial tube.

Another embodiment of the invention provides a device for embalming a corpse. The device generally comprises an arterial tube, a venous tube, and a pump. The pump generally comprises a first inlet configured to be coupled with an outlet of an embalming fluid tank via the arterial tube, a first outlet configured to be coupled to a corpse via the arterial tube, a second inlet configured to be coupled with the corpse via the venous tube, and a second outlet configured to be coupled with an inlet of a waste fluid tank via the venous tube. The pump is configured to simultaneously pump embalming fluid in to the corpse via the arterial tube and pump waste fluid out of the corpse via the venous tube.

Yet another embodiment of the invention provides a device for embalming a corpse. The device generally comprises an arterial tube, a venous tube, a first pump, and a second pump. The first pump is generally comprises a first inlet configured to be coupled with an outlet of an embalming fluid tank via the arterial tube, and a first outlet configured to be coupled to a corpse via the arterial tube. The second pump generally comprises a second inlet configured to be coupled with the corpse via the venous tube, and a second outlet configured to be coupled with an inlet of a waste fluid tank via the venous tube. The first pump is configured to pump embalming fluid in to the corpse via the arterial tube, and the second pump is configured to pump waste fluid out of the corpse via the venous tube, the first pump and the second pump being configured to operate simultaneously.

### BRIEF DESCRIPTION OF THE DRAWINGS

Embodiments of the present invention are explained, by way of example, and with reference to the accompanying drawings. It is to be noted that the appended drawings illustrate only examples of embodiments of this invention and are therefore not to be considered limiting of its scope, for the invention may admit to other equally effective embodiments.

FIG. 1 illustrates an exemplary network of blood vessels according to an embodiment of the invention.

FIG. 2 illustrates an exemplary embalming machine according to an embodiment of the invention.

FIG. 3 illustrates an exemplary pump according to an embodiment of the invention.

FIG. 4 illustrates another exemplary pump according to an embodiment of the invention.

FIG. 5 is a flow diagram of exemplary steps of an embalming process according to an embodiment of the invention.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention.

Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

The following is a detailed description of embodiments of the invention depicted in the accompanying drawings. The embodiments are examples and are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

As described above, because a human body can begin rapidly decomposing after death, it is important to preserve the body via an embalming process to stop, or at least significantly slow down the rate of decomposition. In general the embalming process may involve disinfection, preservation, and restoration. The primary purpose of embalming is disinfection to remove micro-organisms and pathogens that may remain alive in the body and inadvertently infect other human beings that may come in contact with the dead body.

Another purpose of embalming is to preserve the body by preventing putrefaction and decomposition, at least until burial, cremation, entombment, etc. can take place. The preservation of the body can obviate exposure of friends and family to the unpleasant odor and appearance of a body that is left uncared for. Yet another purpose of embalming is the restoration of the human body to a more life like appearance. Restoration may involve, for example, shaving, cleaning and clipping nails, washing hair, applying one or more cosmetic products to the body to prevent dehydration, give the body a natural appearance, etc.

Chemical preservation of human bodies may also facilitate use of the body for educational purposes, to harvest organs for reuse in education, research, training, and the like. For example, bodies may be chemically preserved for anatomical study or education. In some cases, certain organs such as the liver, kidneys, heart, joints, and the like, may be extracted from a chemically preserved body and used for education, research, training, and the like at a distant facility.

Generally, embalming should be performed as soon as possible. Typically, the dead body is first washed thoroughly with soap and water. Next, at least one artery and at least one vein may be opened. For example, one or more of a carotid artery and a femoral artery may be opened, and one or more of a femoral and an axillary vein may be opened. Traditional embalming methods only involve injecting an embalming solution into the body via the opened artery, e.g., the carotid or femoral artery using an embalming machine. The high pressure of injection forces the embalming fluid into the capillaries of the body and eventually into the cells. The embalming fluid may react with soluble albumins in the cells and convert them into albuminoids and gels which do not break down as easily. Furthermore, the embalming fluid may destroy bacteria and other micro-organisms, thereby halting, or at least delaying decomposition.

The injection of the embalming fluid also displaces the blood in the body which may exit via the opened vein. However, the conventional embalming method has several problems. In particular, during the embalming process, blood clots can get stuck in small blood vessels, thereby resulting in a poor distribution of the embalming solution and inadequate drainage of blood, which can result in premature decomposition. In some cases, the blood clots may also result in swelling of parts of the body due to the accumulation of embalming fluid, thereby adversely affecting the appearance of the body.

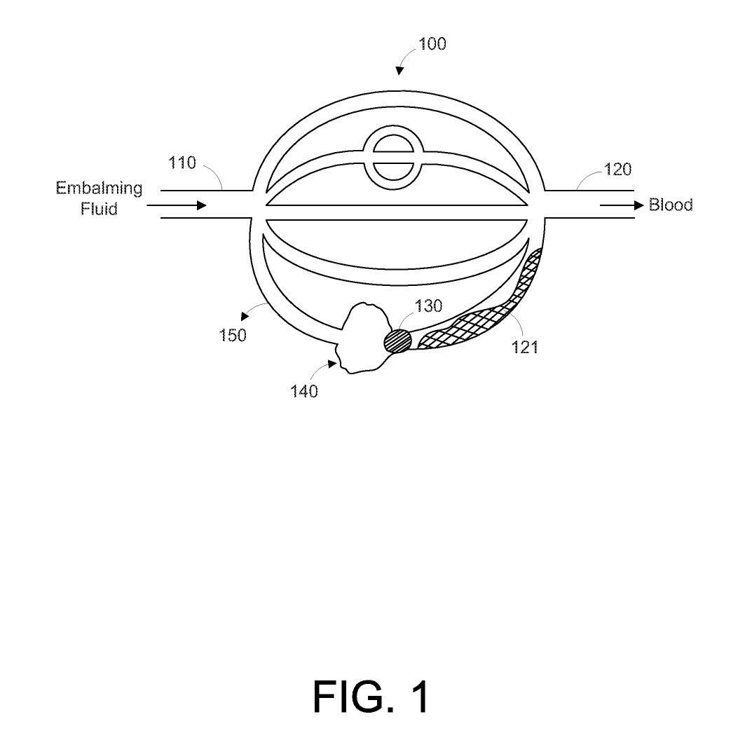

FIG. 1, illustrates a blood clot 130 in a network of blood vessels 100. As shown in FIG. 1, an embalming fluid may be injected into the network of blood vessels 100 via an artery 110. The embalming fluid may flow through the network of blood vessels 100 and displace the blood contained therein via the vein 120. However, because the blood clot 130 becomes stuck in the vessel 150 of the network of blood vessels 100, blood may not drain properly from the vessel 150. For example, the blood 121 may not be displaced from the vessel 150 and remain therein. Such remnant blood may contain bacteria and blood enzymes which may result in the premature decomposition of the body.

Furthermore, the high pressure of injection of the embalming fluid may cause a portion 140 of the vessel 150 to swell due to the collection of the embalming fluid. Such obstruction may be seen in the form of external swelling or discoloration in parts of the body. It is also possible that the high pressure of injection of the embalming fluid and/or the swelling may cause one or more blood vessels to eventually rupture, leading to the embalming fluid, blood, etc. being dispersed in and around the body.

Traditional solutions to address the problem of improper drainage of blood and poor distribution of embalming fluid caused due to blood clots generally involve making further incisions in the body to drain blood from areas where blood clots may be stuck and blocking proper drainage. Studies indicate that some 60-70% of embalmings require multiple additional incisions to remove blood clots and/or remove blood from vessels near blood clots. It is undesirable to make such multiple incisions which result in visible wounds on the body. Moreover, having to make multiple incisions greatly increases the time required for the embalming process, and can be extremely frustrating, labor intensive, and often disappointing for the embalmer.

In some cases, it is possible that a stuck blood clot in a blood vessel may create a difference in pressure on either side of the blood clot in the blood vessel. For example, referring to FIG. 1, the pressure on the portion of the vessel 150 to the left of the blood clot 130 may be much greater than the portion of vessel 150 to the right of the blood clot 130. In parts of the blood vessel that have a lower pressure, it is possible the blood vessel may simply collapse. Collapsing of blood vessels may also result in an adverse affect in the external appearance of the body. Furthermore, it is very difficult to reopen a blood vessel once it has collapsed, as it may require injection of fluid at a very high pressure which could damage parts of the blood vessel.

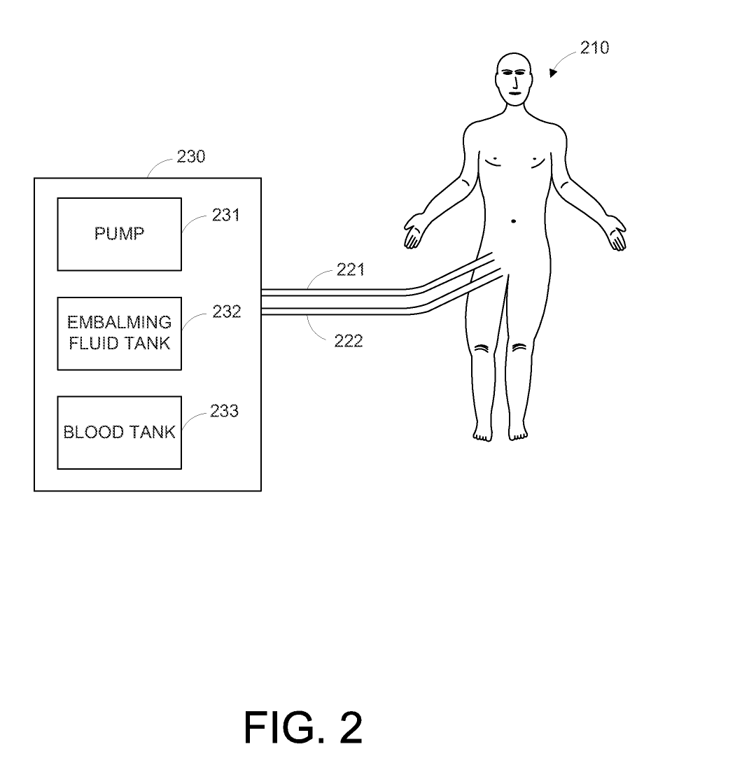

Embodiments of the invention provide novel methods, systems, and apparatus for an embalming process which greatly reduces the likelihood of blood clots getting embedded or stuck in the blood vessels, thereby clogging them. FIG. 2 illustrates an exemplary system for performing an embalming process, according to an embodiment of the invention. As illustrated in FIG. 2, an embalming system 230 may include a pump 231, an embalming fluid tank 232, and a blood tank 233. The embalming fluid tank may be configured to store an embalming fluid which is to be pumped into the corpse 210. In one embodiment, the embalming fluid may include a combination of one or more of formaldehyde, ethanol, methanol, or other like solvents. Any type of embalming fluid may be used, and embodiments of the invention are not limited by the type or composition of embalming fluid that is used.

In one embodiment, the pump 231 may be configured to pump the embalming fluid contained in the embalming fluid tank 232 into the corpse 210. Furthermore, the pump 231 may be configured to simultaneously pump blood out of the corpse 210 and into the blood tank 233. In some embodiments, the blood tank 233 may be omitted, and the blood and other fluids pumped out of the corpse 210 may simply be directed to a drain.

With reference to FIG. 2, an arterial tube 221 is provided to pump the embalming fluid from the embalming fluid tank to the corpse 210, and a venous tube 222 is provided for pumping blood out of the corpse 210. In one embodiment of the invention, the arterial tube 221 may include an arterial cannula and a first polyvinyl chloride (PVC) tube (not shown in FIG. 2). The arterial cannula may be placed inside an artery of the body, for example, the carotid or femoral artery. A clamp may be used to secure the arterial cannula in the artery. The first PVC tube may connect the arterial cannula to the pump 231.

Similarly, the venous tube 222 may include a venous cannula and a second PVC tube. The venous cannula may be placed inside a vein, for example, the axilliary vein or the femoral vein. Again, a clamp may be used to secure the venous cannula in the desired vein. The second PVC tube may connect the venous cannula to the pump 231.

By simultaneously pumping blood out of the corpse 210 while pumping the embalming fluid into the corpse 210, embodiments of the invention greatly reduce the likelihood of blood clots becoming stuck in blood vessels. For example, referring back to FIG. 1, creating a suction pressure in the vein 120 may facilitate dislodging the blood clot 130 that is stuck in the vessel 150. Furthermore, even if the blood clot 130 is not dislodged, the suction pressure may cause the blood 121 to be sucked out of the vessel 150, thereby obviating the problem of un-drained blood which may prematurely decompose the corpse. Another advantage of embodiments of the invention is that the injection of embalming fluid into the corpse may be done at a much lower pressure in comparison to the prior embalming systems. This is because the applied controlled suction of blood from the body obviates the need for high pressures needed to push the blood out of the body via the injection of the embalming fluid.

The pump 231 may be any type of pump. For example, in one embodiment, the pump 231 may be a peristaltic pump. In an alternative embodiment, the pump 231 may be a lobe pump. The particular type of pump used is not limiting on embodiments of the invention. In general any type of pump capable of pumping a fluid into a corpse and simultaneously pumping a fluid out of the corpse at desired pressure levels may be used.

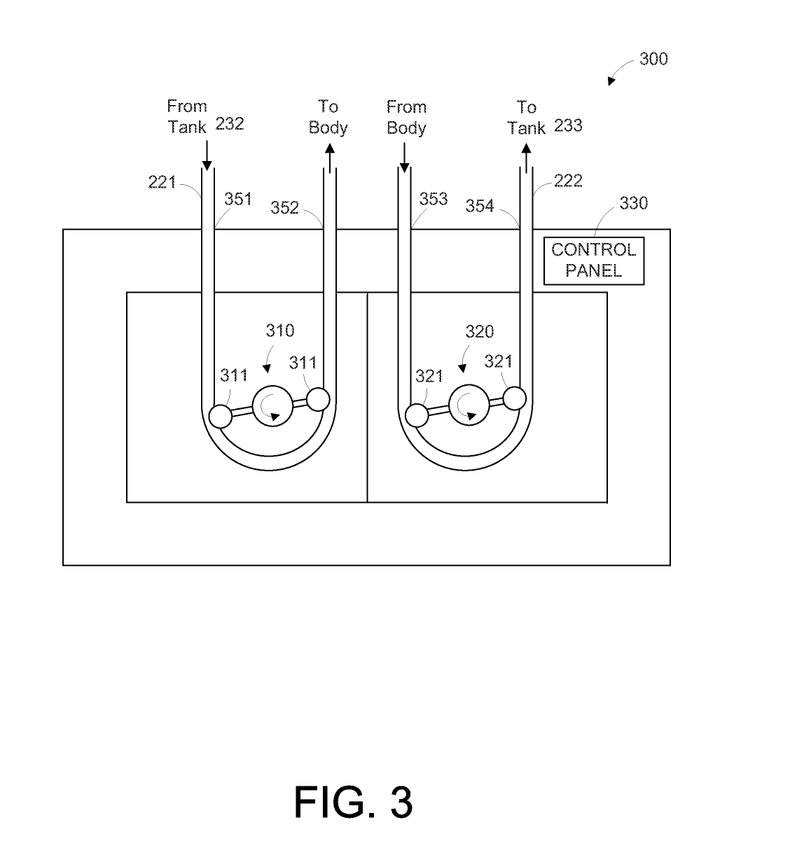

FIG. 3 illustrates an exemplary pump 300 according to an embodiment of the invention. In particular, a peristaltic pump 300 is shown as an example of an embodiment of the invention. As illustrated in FIG. 3, the pump 300 may include two pumping devices 310 and 320, in one embodiment. The pumping device 310 may be coupled to the embalming fluid tank 232 and the corpse 210 via the arterial tube 221 (see FIG. 2 also). In one embodiment, the arterial tube 221 may pass through an inlet 351 and an outlet 352 of the pump 300, as illustrated in FIG. 3. The inlet 351 may be coupled to an outlet of the embalming fluid tank 232 via the arterial tube 221, and the outlet 352 may be coupled to an artery of the body 210 via the arterial tube 221.

During operation, the pump 310 may move the rollers 311 in a circular motion, for example, in an anti-clockwise motion as illustrated in FIG. 3. The circular motion of the rollers 311 may squeeze the arterial tube 221 and displace embalming fluid such that the embalming fluid flows from the embalming fluid tank 232 to the body 210. Similarly, the rollers 321 of pump 320 may move in a circular motion (anti-clockwise in FIG. 3) and displace blood contained in the venous tube 222 such that blood flows from the body 210 to the blood tank 233 via the inlet 353 and outlet 354 of pump 300. The inlet 353 may be coupled to a vein of the body 210 and the outlet 354 may be coupled to an inlet of the blood tank 233.

The pump 300 may be operated until all or most of the blood and waste fluid from the body has been. For example, the pump may be operated until the fluid exiting from the body can be identified as being mostly the embalming fluid that is being pumped in.

In one embodiment, the pump 300 may include a control panel 330 for controlling the flow of fluids through the arterial tube 221 and the venous tube 222. The control panel 330 may include one or more of buttons, knobs, digital screen, analog scale, or the like for selecting a flow rate, pressure, etc. for the fluids being transferred via the arterial tube 221 and the venous tube 222. For example, the flow rate and pressure of the fluids may be controlled by adjusting the speed of rotation of the pumping devices 310 and 320.

In one embodiment of the invention, the flow rate and pressure of fluids may be the same for the arterial tube 221 and the venous tube 222. However, in alternative embodiments, the rate of flow and/or pressure of the embalming fluid in to the body via the arterial tube 221 may differ from the rate of flow of blood from the body via the venous tube 222. Accordingly, in some embodiments the control panel 330 may include separate features for individually controlling the pressure, flow rate, etc., of the fluids in the arterial and venous tubes.

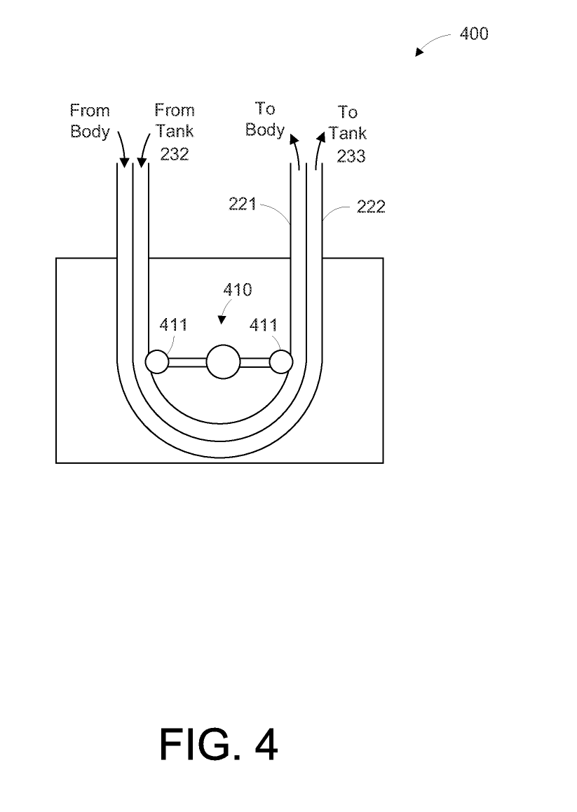

FIG. 4 illustrates another exemplary pump 400 according to an embodiment of the invention. The pump 400 may include a single pumping device 410 capable of displacing fluids in both, the arterial tube 221 as well as the venous tube 222. As shown in FIG. 4, the arterial tube 221 and the venous tube 222 may be placed in such a way that the rollers 411 of the device 410 displace liquids in both the arterial tube 221 and the venous tube 222. While the arterial tube 221 is shown as being in between the rollers 411 and the venous tube 222 in FIG. 4, in alternative embodiments, both the arterial tube 221 and the venous tube 222 may be adjacent to and in contact with the rollers 411 of the device 410.

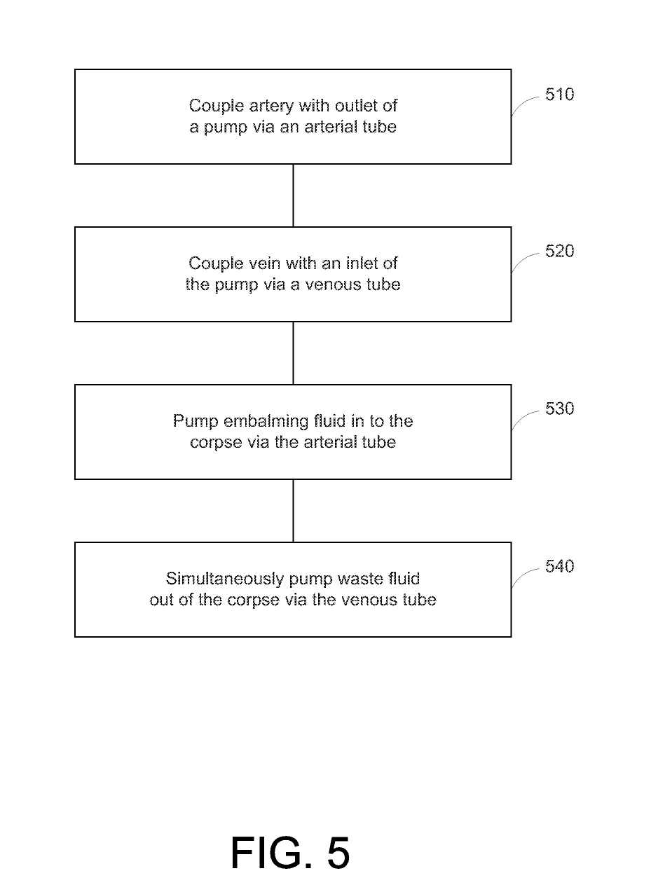

FIG. 5 is a flow diagram of exemplary steps performed during an embalming process according to an embodiment of the invention. In step 510, an artery of a corpse may be coupled with an outlet of a pump via an arterial tube. In step 520, a vein of the corpse may be coupled with an inlet of the pump via a venous tube. In step 530, embalming fluid may be pumped into the corpse via the arterial tube. In step, 540, waste fluid may be pumped out of the corpse via the venous tube at the same time that the embalming fluid is being pumped in to the corpse via the arterial fluid.

By providing an embalming device capable of injecting embalming fluid in to a corpse while simultaneously pumping waste fluid out of the corpse, embodiments of the invention facilitate better distribution of embalming fluid in the body, and better drainage of the waste fluids from the body. Furthermore, the suction pressure provided by the pumping out of waste fluids may facilitate dislodging of blood clots that may become stuck in one or more blood vessels. Furthermore, the flow rate of the injection and the extraction of fluids from the body may be controlled (individually in some embodiments), which allows the maintenance of a desirable pressure in the blood vessels and avoiding the collapsing of blood vessels due to the lack of pressure therein.

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

What is claimed is:

1. An embalming method, comprising:
coupling an arterial tube to an artery of a corpse and an outlet of a pump;
coupling a venous tube to a vein of the corpse and an inlet of the pump;
pumping an embalming fluid into the corpse via the arterial tube; and
pumping waste fluid out of the corpse via the venous tube while the embalming fluid is being pumped into the corpse via the arterial tube.

2. The method of claim 1, wherein the embalming fluid is pumped from an embalming fluid tank, and wherein the waste fluid pumped out of the corpse is directed to one of a waste fluid tank and a drain.

3. The method of claim 2, wherein the arterial tube is coupled to an outlet of the embalming fluid tank, and wherein the venous tube is coupled to the inlet of the waste fluid tank.

4. The method of claim 1, wherein the pressure of pumping embalming fluid in to the corpse via the arterial tube is the same as the pressure of pumping waste fluid out of the corpse via the venous tube.

5. The method of claim 1, wherein the pressure of pumping embalming fluid in to the corpse via the arterial tube is different from the pressure of pumping waste fluid out of the corpse.

6. The method of claim 1, wherein the pump is one of a peristaltic pump and a lobe pump.

7. The method of claim 1, wherein the pump comprises a first pumping device and a second pumping device, wherein the first pumping device is configured to pump the embalming fluid in to the corpse via the arterial tube, and wherein the second pumping device is configured to pump waste fluid out of the corpse.

8. A device for embalming a corpse, comprising:
an arterial tube;
a venous tube; and
a pump comprising:
a first inlet configured to be coupled with an outlet of an embalming fluid tank via the arterial tube;
a first outlet configured to be coupled to a corpse via the arterial tube;
a second inlet configured to be coupled with the corpse via the venous tube; and
a second outlet configured to be coupled with one of an inlet of a waste fluid tank and a drain via the venous tube,
wherein the pump is configured to simultaneously pump embalming fluid in to the corpse via the arterial tube and pump waste fluid out of the corpse via the venous tube.

9. The device of claim 8, wherein the pump further comprises a control panel for selecting a pressure of pumping embalming fluid in to the corpse via the arterial tube and a pressure of pumping fluid out of the body via the venous tube.

10. The device of claim 8, wherein the pump is a peristaltic pump.

11. The device of claim 8, wherein the pump is a lobe pump.

12. A device for embalming a corpse, comprising:
an arterial tube;
a venous tube;
a first pump comprising:
a first inlet configured to be coupled with an outlet of an embalming fluid tank via the arterial tube; and
a first outlet configured to be coupled to a corpse via the arterial tube; and
a second pump comprising:
a second inlet configured to be coupled with the corpse via the venous tube; and
a second outlet configured to be coupled with one of an inlet of a waste fluid tank and a drain via the venous tube,
wherein the first pump is configured to pump embalming fluid in to the corpse via the arterial tube and the second pump is configured to pump waste fluid out of the corpse via the venous tube, the first pump and the second pump being configured to operate simultaneously.

13. The device of claim 12, wherein the first pump and the second pump each comprise a control panel for individually selecting respectively a pressure of pumping embalming fluid in to the corpse via the arterial tube and a pressure of pumping fluid out of the body via the venous tube.

14. The device of claim 12, wherein the first pump is a peristaltic pump.

15. The device of claim 12, wherein the first pump is a lobe pump.

16. The device of claim 12, wherein the second pump is a peristaltic pump.

17. The device of claim 12, wherein the second pump is a lobe pump.
